(19) United States
(12) Patent Application Publication
(10) Pub. No.: US 2017/0193504 A1
(43) Pub. Date: Jul. 6, 2017

(54) FINANCIAL MANAGEMENT SYSTEMS AND ASSOCIATED METHODS

(71) Applicant: PayPal Inc., San Jose, CA (US)

(72) Inventors: Sandra Lynn Godsey, San Jose, CA (US); Michael Charles Todasco, Santa Clara, CA (US)

(21) Appl. No.: 14/984,964

(22) Filed: Dec. 30, 2015

(51) Int. Cl. G06Q 20/40; G06Q 50/00; G06Q 40/06; G06Q 20/36

(52) U.S. Cl. CPC G06Q 20/405; G06Q 20/36; G06Q 50/01; G06Q 40/06

(57) ABSTRACT

Embodiments of the present disclosure are related to electronic commerce. A method may include comparing at least one of an electronic transaction initiated via an electronic wallet application and a user account status to the one or more conditions of a financial plan. The method may further include generating an event based on a comparison of the at least one of the initiated electronic transaction and the user account status to the one or more conditions.

### FIELD

The present disclosure relates generally to electronic commerce. More specifically, the present disclosure includes embodiments related to customizable financial management systems for use within electronic commerce.

### BACKGROUND

Mobile electronic devices (e.g., smartphones) are increasingly being used as electronic wallets (also referred to as “mobile wallets” or “digital wallets”) to conduct electronic transactions online or offline (i.e., making payments at physical store locations). As will be understood by a person having ordinary skill in the art, electronic wallet applications include a software component and an information component, which may include, for example, a user's shipping address, billing address, and payment information/credentials including credit card numbers, expiration dates, and security numbers. To carry out an electronic transaction via an electronic wallet application, a customer (i.e., a consumer) may choose from various funding sources, such as different credit cards, bank accounts, debit cards, and the like.

As will be appreciated, some consumers may have a difficult time with disciplined adherence to a budget, saving for specific items, appropriately prioritizing spending, spending habits, and money management in general. Often, money is spent spontaneously, which may force a consumer to go over budget and/or borrow money.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 is a block diagram of a networked system, according to an embodiment of the present disclosure;

FIG. 2 is a block diagram of a computer system, according to an embodiment of the present disclosure;

FIG. 3 is a flowchart depicting a method, in accordance with an embodiment of the present disclosure; and

FIG. 4 is a flowchart depicting another method, in accordance with an embodiment of the present disclosure.

### DETAILED DESCRIPTION

Various embodiments, as described herein, relate to customizable financial management systems for use within electronic commerce. According to one embodiment, a system may include at least one application program configured to initiate an electronic transaction via an electronic device. For example, the at least one application program may include an electronic wallet application stored on the electronic device. The at least one application program may further be configured to compare at least one of an initiated electronic transaction and a user account status to one or more conditions of a customizable financial plan. For example, the at least one application program may include a financial management application program configured to compare an initiated electronic transaction, a user account status, or both, to the one or more conditions. A user account status may comprise, for example, information related to a user's financial status, such as account balances, an amount of money spent by the user during a time period (e.g., a month), how the user has spent money during a time period, one or more financial transactions initiated by the user, or any other information related to a user's financial situation. Further, the at least one application program may be configured to generate an event based on a comparison of the electronic transaction and/or the user account status to the one or more conditions. As non-limiting examples, the event may comprise an event that penalizes the user or an event that rewards the user.

According to other embodiments, the present disclosure includes methods for operating a financial management system. Various embodiments of such a method may include comparing at least one of an electronic transaction initiated via an electronic wallet application and a user account status to one or more conditions of a financial plan. For example, each electronic transaction initiated by the user may be compared to the one or more conditions (i.e., as defined by the user, a third party, or both). As another example, a user account status including, for example, a total amount of money spent during a time period, a total amount of money spent on specific goods and/or services during the time period, a total number of goods and/services purchased at a specific establishment (or type of establishment) during the time period, may be compared to the one or more conditions. The method may further include generating an event based on the comparison of the at least one of the initiated electronic transaction and the user account status to the one or more conditions. As one example, a reward event may be generated if, for example, a defined goal is achieved (e.g., an account balance reaches a specific amount, an amount spent is less than or equal to a defined budget, etc.). A reward event may comprise, for example only, an increase in a budget, a transfer of funds from one account (e.g., a savings account) to another account (e.g., a spending account), allocating funds to a “bonus” account, a positive social network post, or any combination thereof. Further, for example, a penalty event may be generated if, for example, a defined goal is not achieved (e.g., a user exceeds a budget for a given time period, the user spends more than a budgeted amount on a specific item, etc.). A penalty event may comprise, for example only, a decrease in a budget, freezing of an account, a transfer of funds from one account (e.g., a spending account) to another account (e.g., a savings account), a negative social network post, or any combination thereof

Yet other embodiments of the present disclosure comprise computer-readable media storage storing instructions that when executed by a processor cause the processor to perform instructions in accordance with one or more embodiments described herein.

Other aspects, as well as features and advantages of various aspects, will become apparent to those of skill in the art though consideration of the ensuing description, the accompanying drawings and the appended claims.

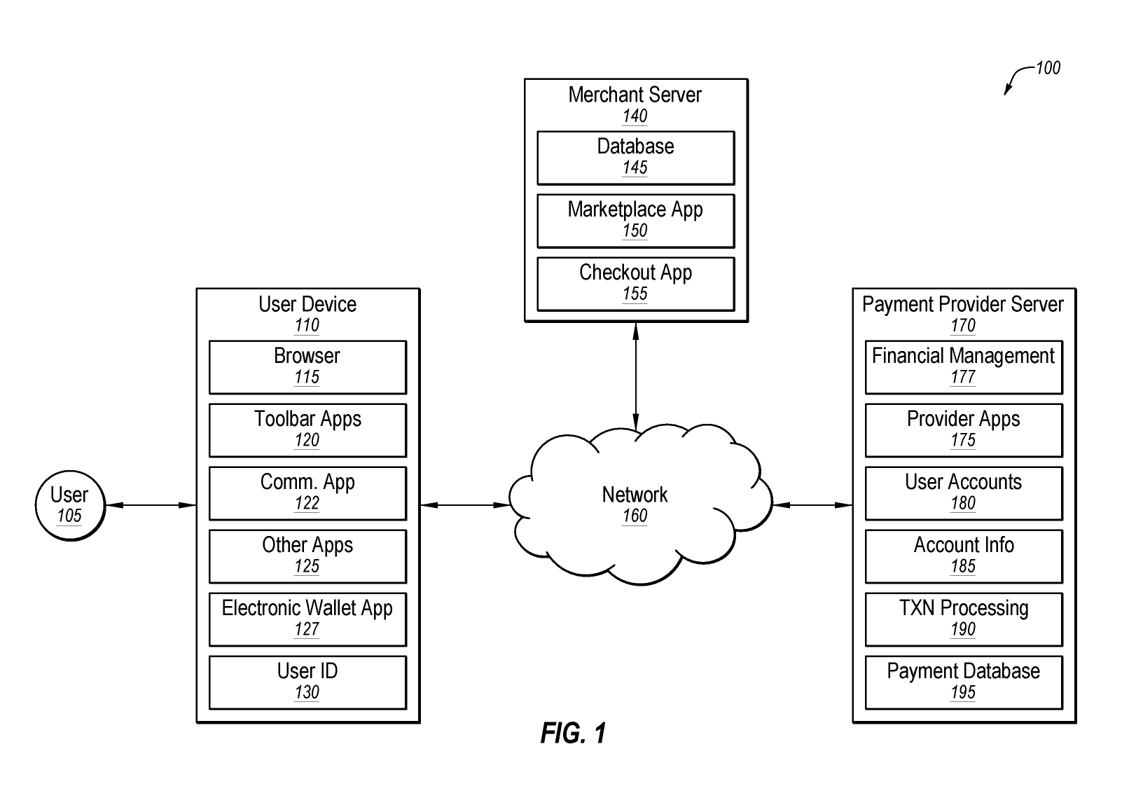

FIG. 1 is a block diagram of a networked system 100 configured for implementing a financial management system, in accordance with various embodiments of the present disclosure. System 100 includes a user device 110, a merchant server 140, and a payment provider server 170 in communication via a network 160. Payment provider server 170 may be maintained by a payment provider, such as PayPal, Inc. of San Jose, Calif. A user 105, such as a consumer, may utilize user device 110 to perform a transaction using payment provider server 170. Note that transaction, as used herein, refers to any suitable action performed using user device 110, including payments, transfer of information, display of information, etc.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115, which may be used, for example, to provide a convenient interface to permit user 105 to browse information available over network 160. For example, in one embodiment, browser application 115 may be implemented as a web browser configured to view information available over the Internet. User device 110 may also include one or more toolbar applications 120 which may be used, for example, to provide user-side processing for performing desired tasks in response to operations selected by user 105. In one embodiment, toolbar applications 120 may display a user interface in connection with browser application 115 as further described herein.

User device 110 may further include other applications 125 as may be desired in particular embodiments to provide desired features to user device 110. For example, other applications 125 may include security applications for implementing user-side security features, programmatic user applications for interfacing with appropriate application programming interfaces (APIs) over network 160, or other types of applications. Other applications 125 may also include email, texting, voice and IM applications that allow user 105 to send and receive emails, calls, and texts through network 160, as well as applications that enable the user to communicate, transfer information, make payments, and otherwise utilize an electronic wallet through the payment provider as disclosed below.

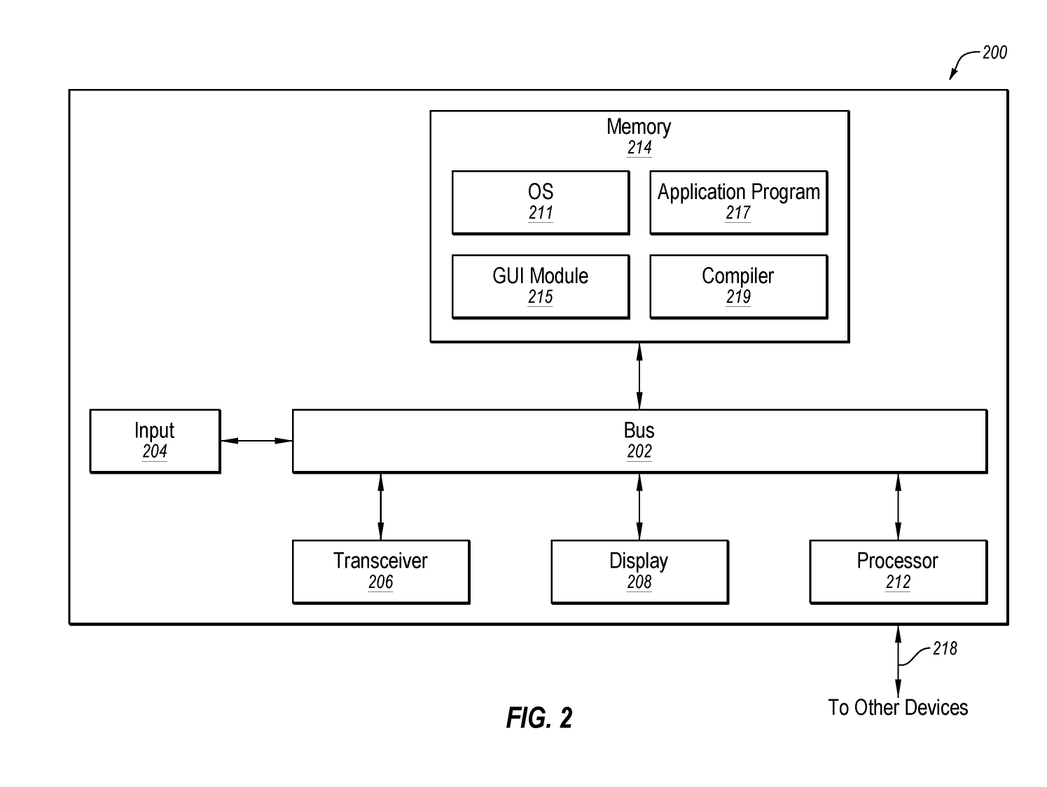

User device 110 may further include one or more applications (e.g., application program 217; see FIG. 2) for implementing one or more embodiments, as described below. For example, other applications 125 may include at least a portion of a financial management application, and user device 110 may further include at least a portion of an electronic wallet application 127.

User device 110 includes one or more user identifiers 130, which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider as further described herein. A communications application 122, with associated interfaces, enables user device 110 to communicate within system 100.

Merchant server 140 may be maintained, for example, by a merchant or seller offering various products and/or services in exchange for payment to be received over network 160. Merchant server 140 may be used for point of sale (POS) or online purchases and transactions. Generally, merchant server 140 may be maintained by anyone or any entity that receives money, which includes charities as well as retailers and restaurants. Merchant server 140 includes a database 145 identifying available goods and/or services (e.g., collectively referred to as items) which may be made available for viewing and purchase by user 105. Accordingly, merchant server 140 also includes a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant server 140 also includes a checkout application 155 configured to facilitate the purchase by user 105 of goods or services identified by marketplace application 150. Checkout application 155 may be configured to accept payment information from or on behalf of user 105 through payment service provider server 170 over network 160, such as using selected funding instruments from electronic wallet application 127. For example, checkout application 155 may receive and process a payment confirmation from payment service provider server 170, as well as transmit transaction information to the payment provider and receive information from the payment provider (e.g., a transaction ID).

Payment provider server 170 may be maintained, for example, by an online payment service provider which may provide payment between user 105 and the operator of merchant server 140. In this regard, payment provider server 170 includes one or more provider applications 175 which may be configured to interact with user device 110 and/or merchant server 140 over network 160 to facilitate the purchase of goods or services, communicate/display information, and send payments by user 105 of user device 110 and as discussed above.

Payment provider server 170 also maintains a plurality of user accounts 180, each of which may include account information 185 associated with individual users. For example, account information 185 may include private financial information of users of devices such as account numbers, passwords, device identifiers, user names, phone numbers, credit card information, bank information, customized financial plan, and other financial information which may be used to by user 105. Advantageously, provider application 175 may be configured to interact with merchant server 140 on behalf of user 105 during a transaction with checkout application 155 to track and manage purchases made by users and which funding sources are used.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments as described herein. As such, transaction processing application 190 may store details of an order associated with a phrase from individual users. Provider application 175 may be further configured to determine the existence of and to manage accounts for user 105, as well as create new accounts if necessary, such as the set-up, management, and use of an electronic wallet for user 105/user device 110.

Payment provider server 170 may further include an application program (e.g., application program 217; see FIG. 2) for implementing one or more embodiments of the present disclosure, as described more fully below. According to one example, payment provider server 170 may include at least a portion of a financial management application 177.

FIG. 2 is a block diagram of a computer system 200 suitable for implementing one or more embodiments of the present disclosure. It should be appreciated that each of user device 110, merchant server 140, and payment provider server 170 (see FIG. 1) may be implemented as computer system 200 in a manner as follows.

Computer system 200 includes a bus 202 or other communication mechanism for communicating information data, signals, and information between various components of computer system 200. Components include an input 204 that processes a user action, such as selecting keys from a keypad/keyboard (e.g., to set one or more conditions to customize a financial plan of a financial management system), selecting one or more buttons or links, etc., and sends a corresponding signal to bus 202. A transceiver 206 transmits and receives signals between computer system 200 and other devices, such as a merchant server, payment provider server, or another user device. In one embodiment, the transmission is wireless, although other transmission mediums and methods may also be suitable. A display 208, such as an LCD screen, displays an image via a graphical user interface (GUI). A processor 212, which can be a micro-controller, digital signal processor (DSP), or other processing component, processes these various signals, such as for display on computer system 200 or transmission to other devices via a communication link 218.

Generally, computer system 200 may operate under control of an operating system (OS) 211 stored in the memory 214, and interface with a user to accept inputs and commands and to present outputs through a GUI module 215. Although GUI module 215 is depicted as a separate module, the instructions performing the GUI functions may be resident or distributed in the operating system 211, an application program 217, or implemented with special purpose memory and processors. Computer system 200 may also implement a compiler 219 that allows application program 217 written in a programming language to be translated into processor 212 readable code. After completion, application program 217 may access and manipulate data stored in memory 214 of computer system 200 using the relationships and logic that are generated using compiler 219.

Further, operating system 211 and application program 217 may include instructions that, when read and executed by system 200, may cause system 200 to perform the steps necessary to implement and/or use embodiments of the present disclosure. Application program 217 and/or operating instructions may also be tangibly embodied in memory 214 and/or data communications devices, thereby making a computer program product or article of manufacture according to an embodiment of the disclosure. As such, the term “application program” as used herein is intended to encompass a computer program accessible from any computer readable device or media. Such a medium may take many forms, including but not limited to, non-volatile media, volatile media, and transmission media. In various implementations, non-volatile media includes optical or magnetic disks, volatile media includes dynamic memory, such as system memory 214, and transmission media may include coaxial cables, copper wire, and fiber optics, including wires that comprise bus 202. In one example, transmission media may take the form of acoustic or light waves, such as those generated during radio wave, optical, and infrared data communications.

Application program 217 may exist on an electronic device (e.g., user device 110; see FIG. 1) or a server (e.g., payment provider server 170; see FIG. 1). Furthermore, portions of application program 217 may be distributed such that some of application program 217 may be included on a computer readable media within an electronic device (e.g., user device 110) and some of application program 217 may be included on a server (e.g., payment provider server 170). In other embodiments, application program 217 may be configured to run on user device 110, payment provider server 170, another computing device, or any combination thereof. As a specific example, application program 217 may exist on payment provider server 170 and may be accessible to user 105 via user device 110.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Various embodiments of the present disclosure are related to a financial management system, which may assist a user (i.e., user 105; see FIG. 1) in achieving one or more financial (e.g., spending and/or saving) goals. In accordance with various embodiments, the financial management system may allow a user to customize a financial plan (e.g., define financial goals, budgets, rewards, penalties, etc.) via setting one or more conditions (e.g., to monitor spending and/or savings, avoid frivolous spending, etc.). Further, the financial management system may generate various events based on whether the user has met, or failed to meet, the one or more conditions of the customized financial plan.

As described more fully below, the financial management system may be implemented via one or more application programs (e.g., application program 217; see FIG. 2), which may exist on a mobile device (e.g., user device 110), a server (e.g., payment provider server 170), or a combination thereof. More specifically, in one embodiment, an electronic wallet application (e.g., electronic wallet application 127; see FIG. 1), which may be configured to initiate an electronic transaction, may be at least partially stored on a mobile device (e.g., user device 110). Further, a financial management application (e.g., financial management application 177; see FIG. 1), which may include a user's customized financial plan and which may be configured to compare a user's account status and/or transactions to the user's customized financial plan, may be at least partially stored on a remote server (e.g., payment provider server 170).

As noted above, the financial management system may be customizable via one or more conditions. For example, one or more conditions may be defined (e.g., by a user (e.g., via the user's mobile device), a third party, or both), and based on one or more user transactions and/or a user account status compared to the one or more conditions, the user may receive rewards (i.e., for meeting a goal as defined by one or more conditions) and/or penalties (i.e., for failing to meet a goal as defined by one or more conditions). It is noted that the conditions, rewards and penalties may be defined by a user, a third party (e.g., financial advisor, a user's guardian, a user's parent or friend, etc.), or both.

As one example, a spending limit (e.g., per month) for an account (e.g., credit card account) may be set by a user (i.e., via a condition). If the user reaches the defined spending limit, the account may be frozen, and/or a notice may be sent to the user indicating that the limit has been reached. As another example, if the user approaches or reaches the spending limit, the spending limit may be modified (e.g., decreased as a penalty for approaching or reaching the limit). As yet another example, if the user spends an amount less than or equal to the spending limit of the account, the user may receive a reward (e.g., the spending limit may be increased and/or money may be transferred to a different account (e.g., a spending account)) (or allocated separately within a single account) as a bonus, for example.

According to another embodiment, the financial management system may be configured to transfer funds from one account to another account, or allocate funds separately within a single account, based on a user reaching, or failing to reach, one or more user-defined goals (i.e., defined via one or more conditions). For example, if a user reaches a spending and/or savings goal (e.g., spends less than a budgeted amount), money may be transferred from one account (e.g., a savings account) to a second account (e.g., a spending/checking account), or vice-versa. As another example, if the user reaches a spending and/or savings goal, the user's spending limit may be modified (e.g., increased).

In accordance with another embodiment, the financial management system may be configured to deter spending at certain establishments and/or on certain items (i.e., goods/services). For example, a condition may be set to penalize a user (e.g., via decreasing a budget) if the user makes a purchase (e.g., via an electronic transaction) at a specific retail establishment or a type of retail establishment (e.g., a high-end store, a socially-irresponsible store, etc.), purchases a specific good (e.g., a brand-name good, an eco-unfriendly good, a full-priced good, a good that does not meet a defined product rating standard, etc.), purchases a specific service (e.g., a high-end service), or a combination thereof. As another example, a user's card (e.g., credit or debit card) may be denied if user attempts a specific purchase (e.g., at a high-end retail shop, for high-end goods/services, or both). According to another example, a condition may be set to penalize a user (e.g., via decreasing a budget) if the user frequents a certain establishment, or type of establishment more than a specific number of times. As a more specific example, if the user visits an establishment or type of establishment (e.g., a restaurant) more than a specific number of times and/or spends more than an allocated amount of money at the establishment, the user may be penalized (e.g., an account may be frozen, a budget decreased, money may be transferred from a spending account, etc.). In contrast, if the user visits an establishment, or type of establishment, less than a specific number of times, spends less than an allocated amount of money at an establishment, or type of establishment, or a combination thereof, the user may be rewarded (e.g., additional money may be allocated to a spending account as a bonus).

Similarly, the financial management system may be configured to encourage a user to support certain establishments and/or encourage a user to purchase certain items. For example, a condition may be set to reward a user (e.g., via increasing a budget) if the user makes a purchase (i.e., via an electronic transaction) at a specific retail establishment or a type of retail establishment (e.g., a discount store, a second-hand store, a socially-responsible store, an eco-friendly store, etc.), purchases a specific good (e.g., an on-sale good, a generic good, an environmentally-friendly good, a good that meets a specific product rating standard, etc.), purchases a specific service (e.g., a discount service), or any combination thereof.

In yet another embodiment, the financial management system may be configured to share information related to activity of a user (e.g., spending and/or saving activity) via one or more social media accounts. As an example, if a user fails to achieve a financial goal (e.g., overspends during a specific time period (e.g., a month), or purchases items from a socially-irresponsible establishment, etc.), information related to the failure may be “posted” or “shared” via one or more social media accounts (e.g., the user's social media accounts). Similarly, if a user achieves a financial goal (e.g., spends less that a budgeted amount during a specific time period (e.g., a month), or purchases items from a discount store, etc.), information related to the achievement may be “posted” or “shared” via one or more social media accounts.

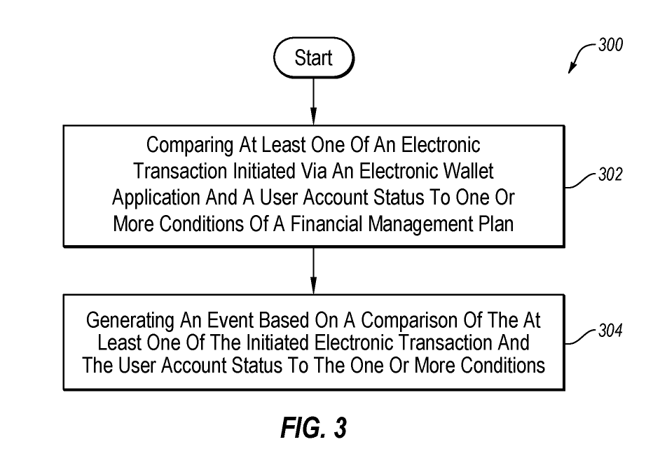

FIG. 3 is a flowchart illustrating an example method 300. Method 300 may be arranged in accordance with at least one embodiment described herein. Method 300 may be implemented, in some embodiments, by a system, such as the system 100 and/or 200 of FIGS. 1 and 2, respectively. Although illustrated as discrete blocks, various blocks of method 300 may be divided into additional blocks, combined into fewer blocks, or eliminated, depending on the desired implementation.

Method 300 may include comparing at least one of an electronic transaction initiated via an electronic wallet application and a user account status to the one or more conditions of a financial management plan (depicted at block 302). For example, a user (e.g., user 105; see FIG. 1) may initiate an electronic transaction via electronic wallet application 127 of user device 110. Upon receiving notice of the electronic transaction (e.g., via network 160), financial management application 177 may compare specifics of the electronic transaction (e.g., a dollar amount, type of item(s) purchased, an establishment at which the electronic transactions is initiated), a user account status (e.g., an amount of money spent during the current month, account balance(s), or any other information related to a user's financial situation and/actions), or both, to the one or more conditions of the user's customized financial plan. Further, method 300 may include generating an event based on a comparison of the at least one of the initiated electronic transaction and the user account status to the one or more conditions (depicted at block 304). For example, upon determining that at least one condition has been met based on the comparison, financial management application 177 may convey one or more signals to electronic wallet application 127. Further, in response to receipt of the one or more signals, electronic wallet application 127 may generate one or more events (e.g., electronic wallet application may freeze an account, transfer money (e.g., from one account to another), convey a message to the user, or any combination thereof).

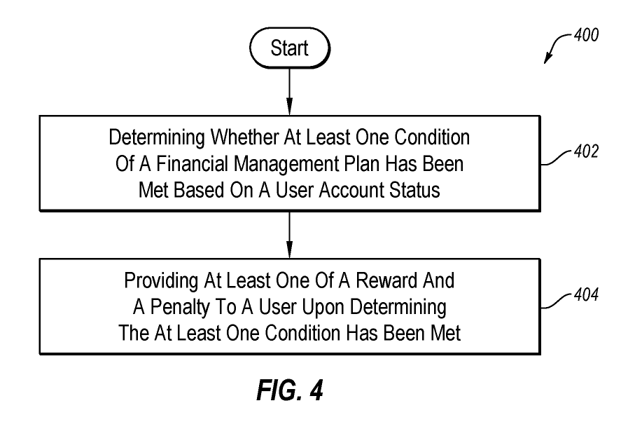

FIG. 4 is a flowchart illustrating another method 400, in accordance with one or more embodiments. Method 400 may be implemented, in some embodiments, by a system, such as the system 100 and/or 200 of FIGS. 1 and 2, respectively. Although illustrated as discrete blocks, various blocks of method 400 may be divided into additional blocks, combined into fewer blocks, or eliminated, depending on the desired implementation.

Method 400 may include determining whether at least one condition of a financial management plan has been met based on a status of at least one user account (depicted at block 402). For example, financial management application 177 (see FIG. 1) may determine whether at least one condition of a user's customized financial plan (e.g., stored at payment provider server 170) has been met based on the user's account status (e.g., an amount of money spent during the current month, account balance(s), or any other information related to a user's financial situation and/or transactions). Further, method 400 may include providing at least one of a reward and a penalty to a user upon determining the at least one condition has been met (depicted at block 404). As an example, if financial management application 177 determines that the user has met, or not met, one or more user-defined goals (i.e., defined via the at least one condition), a reward and/or a penalty may be provided to the user (i.e., via user device 110). More specifically, for example, upon determining that the at least one condition has, or has not, been met, financial management application 177 may convey a signal to the user's device (e.g., user device 110), wherein electronic wallet application 127, in response to the signal, may perform one or more actions (e.g., freeze an account, modify a budget amount, transfer money (e.g., from one account to another), convey a message to the user, etc.).

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A system, comprising:
at least one application program configured to:
initiate an electronic transaction via an electronic device;
compare at least one of an initiated electronic transaction and a user account status to one or more conditions of a customizable financial plan; and
generate an event based on a comparison of the at least one of the initiated electronic transaction and the user account status to the one or more conditions.

2. The system of claim 1, further comprising a remote server including at least a portion of the application program.

3. The system of claim 1, the at least one application program comprising:
an electronic wallet application configured to initiate the electronic transaction; and
a financial management application configured to compare the at least one of the initiated electronic transaction and the user account status to the one or more conditions.

4. The system of claim 3, wherein the electronic device includes at least a portion of the electronic wallet application and the financial management application.

5. The system of claim 1, wherein the event comprises one of a reward event and a penalty event.

6. The system of claim 1, wherein the event comprises at least one of a transfer of funds from one account to another account, modification of a budget limit of at least one financial account, and disablement of the at least one financial account.

7. A method, comprising:
comparing at least one of an electronic transaction initiated via an electronic wallet application and a user account status to one or more conditions of a financial plan; and
generating an event based on a comparison of the at least one of the initiated electronic transaction and the user account status to the one or more conditions.

8. The method of claim 7, wherein generating an event comprises providing at least one of a reward or a penalty to a user via the electronic wallet application.

9. The method of claim 7, wherein generating an event comprises generating an alert regarding an over-spending event.

10. The method of claim 7, wherein generating an event comprises transferring money from one financial account to another, different financial account.

11. The method of claim 7, wherein generating an event comprises modifying a budget limit of at least one financial account.

12. The method of claim 7, wherein generating an event comprises disabling a funding source associated with the electronic wallet application.

13. The method of claim 7, wherein generating an event comprises generating social media content related to the at least one electronic transaction.

14. The method of claim 7, further comprising generating the financial plan upon receipt of at least one condition of the one or more conditions.

15. One or more non-transitory computer-readable media storing one or more programs that are configured, when executed, to cause one or more machines to execute the method as recited in claim 7.

16. A method, comprising:
determining whether at least one condition of a financial plan has been met based on a user account status; and
providing at least one of a reward and a penalty to a user upon determining the at least one condition has been met.

17. The method of claim 16, further comprising receiving information regarding an electronic transaction initiated via the user and an electronic device.

18. The method of claim 17, wherein determining comprises comparing at least one of a status of at least one user account and the information regarding the electronic transaction to the at least one condition.

19. The method of claim 16, wherein providing comprises at least one of:
modifying a budget limit of at least one user account;
transferring money to or from the at least one user account;
disabling the at least one user account; and
generating social media content related to the at least one user account.

20. One or more non-transitory computer-readable media storing one or more programs that are configured, when executed, to cause one or more machines to execute the method as recited in claim 16.
